(19) United States
(12) Patent Application Publication
(10) Pub. No.: US 2014/0372887 A1
(43) Pub. Date: Dec. 18, 2014

(54) METHOD AND SYSTEM FOR PROVIDING MEDIA CONTENT TOURS

(71) Applicant: THOMSON LICENSING, Issy de Moulineaux (FR)

(72) Inventor: Jageet Singh KHALSA, San Diego, CA (US)

(21) Appl. No.: 13/964,392

(22) Filed: Aug. 12, 2013

Related U.S. Application Data
(60) Provisional application No. 61/836,326, filed on Jun. 18, 2013.

(51) Int. Cl. G06F 3/0484

(52) U.S. Cl. CPC G06F 3/0484
USPC 715/716

(57) ABSTRACT

A method and system are provided. The method and system are for providing media content tours. The method includes generating a list of media content for a media content tour. The list specifies a plurality of media contents. The method further includes assigning a playback order for the media contents specified in the list responsive to user preferences of a user. The method also includes providing, for playback on a display screen, the media contents specified in the list in the assigned playback order as the media content tour.

### CROSS-REFERENCE TO RELATED APPLICATIONS

This application claims the benefit of U.S. Provisional Application Ser. No. 61/836,326 (Attorney Docket No. PU130082), filed Jun. 18, 2013, which is incorporated by reference herein in its entirety.

### TECHNICAL FIELD

The present principles relate generally to media content and, more particularly, to a method and system for providing media content tours.

### BACKGROUND

Typically, media content is provided for a user in a predefined order. The order is specified by a company or other entity that defines a play out list. Unfortunately such a predefined order results in the media being played back the same way all the time, which can become boring and monotonous for a user.

### SUMMARY

These and other drawbacks and disadvantages of the prior art are addressed by the present principles, which are directed to a method and system for providing media content tours.

According to an aspect of the present principles, there is provided a method. The method includes generating a list of media content for a media content tour. The list specifies a plurality of media contents. The method further includes assigning a playback order for the media contents specified in the list responsive to user preferences of a user. The method also includes providing, for playback on a display screen, the media contents specified in the list in the assigned playback order as the media content tour.

According to another aspect of the present principles, there is provided a system. The system includes a list generator for generating a list of media content for a media content tour. The list specifies a plurality of media contents. The system further includes a playback order assigner for assigning a playback order for the media contents specified in the list responsive to user preferences of a user. The system also includes a media content tour provider for providing the media contents specified in the list for playback in the assigned playback order as the media content tour.

According to yet another aspect of the present principles, there is provided a non-transitory computer readable storage medium having computer executable code stored thereon for performing a method. The method includes generating a list of media content for a media content tour. The list specifies a plurality of media contents. The method further includes assigning a playback order for the media contents specified in the list responsive to user preferences of a user. The method also includes providing, for playback on a display screen, the media contents specified in the list in the assigned playback order as the media content tour.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary system 100 for delivering video content to which the present principles may be applied, in accordance with an embodiment of the present principles;

FIG. 2 shows an exemplary processing system 200 to which the present principles may be applied, according to an embodiment of the present principles, is shown;

FIG. 3 shows an exemplary system 300 for providing a media content tour, in accordance with an embodiment of the present principles;

FIG. 4 shows an exemplary method 400 for providing a media content tour, in accordance with an embodiment of the present principles; and

FIG. 5 shows an exemplary user interface 500 for a media content tour, in accordance with an embodiment of the present principles.

### DETAILED DESCRIPTION

The present principles are directed to a method and system for providing media content tours.

Advantageously, the present principles enable the order of playing back media content to be varied based on the preferences of a user. In an embodiment, the preferences are determined from a user profile. In an embodiment, the present principles provide a “content tour” where a user is presented with a series of different content.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Initially, a system for delivering various types of content to a user will be described.

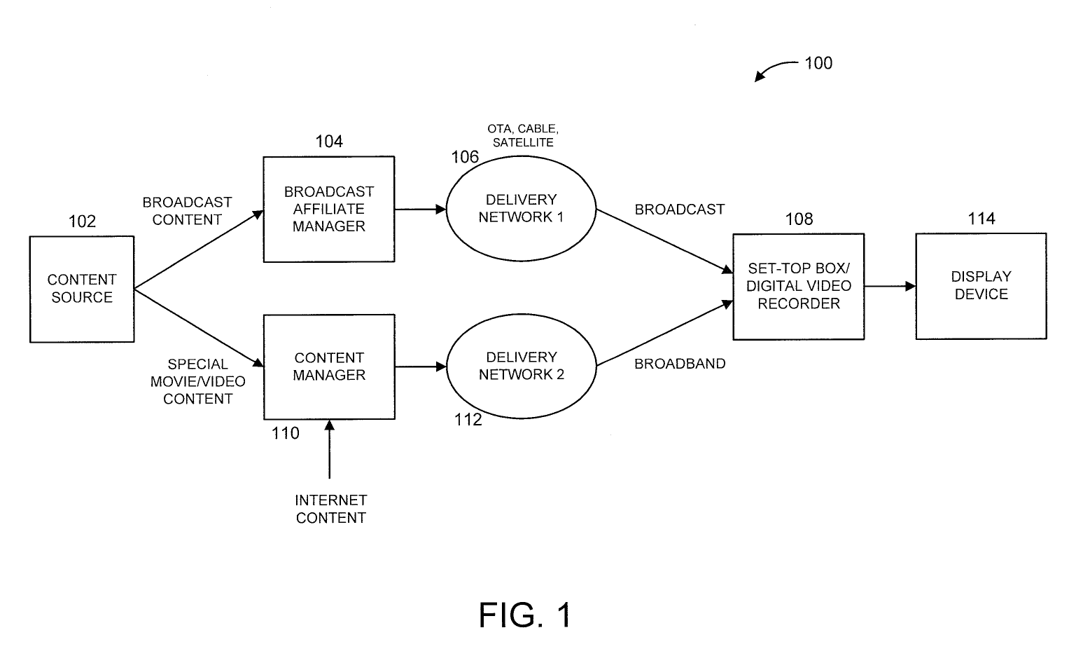

FIG. 1 shows an exemplary system 100 for delivering video content to which the present principles may be applied, in accordance with an embodiment of the present principles. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder (DVR) 108 in a user's home, where the content will form part of the results of subsequent searches by the user.

A second form of content is referred to as special content. Special content may include content that may have been delivered as premium viewing, pay-per-view, or other content otherwise not provided to the broadcast affiliate manager. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system, or explicitly into the search only such that content may be searched that has not yet been delivered to the user's set top box/digital video recorder 108. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

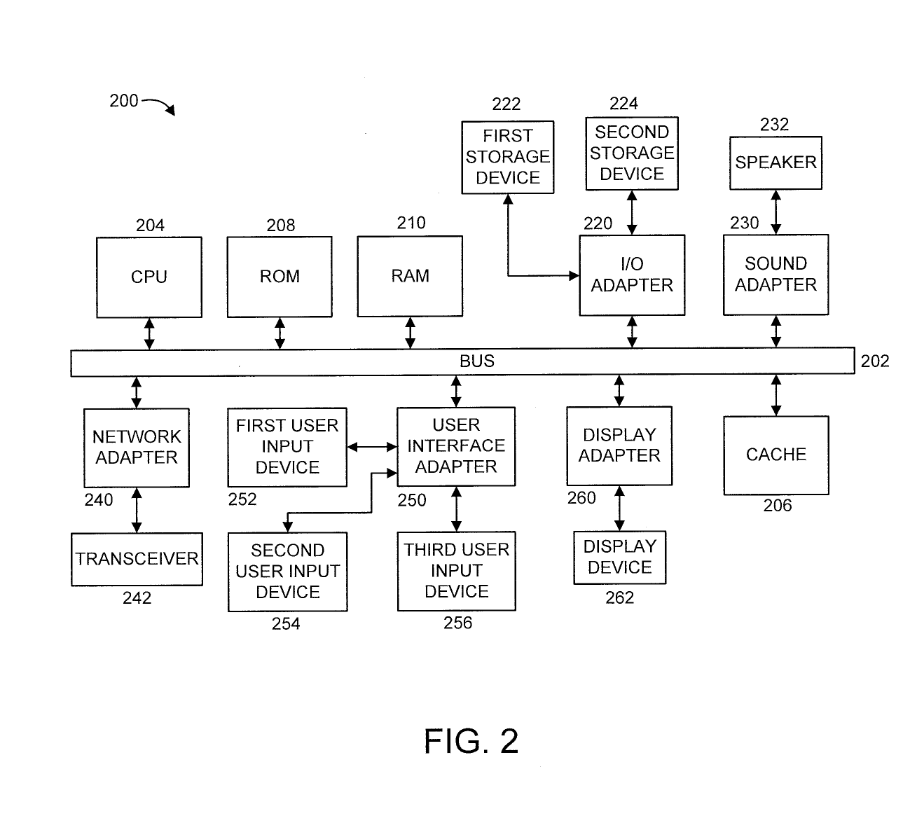

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. The processed content is provided to a display device 114. The display device 114 may be a conventional 2-D type display or may alternatively be an advanced 3-D display. It should be appreciated that other devices having display capabilities such as wireless phones, PDAs, computers, gaming platforms, remote controls, multi-media players, or the like, may employ the teachings of the present disclosure and are considered within the scope of the present disclosure. In some embodiments, at least display device 114, and in other embodiments, also set top box/digital video recorder 108, can be replaced by a processing system having a display such as processing system 200 shown and described with respect to FIG. 2. The processing system 200 can be representative of any media consumption/presentation device.

FIG. 2 shows an exemplary processing system 200 to which the present principles may be applied, according to an embodiment of the present principles, is shown. The processing system 200 includes at least one processor (CPU) 204 operatively coupled to other components via a system bus 202. A cache 206, a Read Only Memory (ROM) 208, a Random Access Memory (RAM) 210, an input/output (I/O) adapter 220, a sound adapter 230, a network adapter 240, a user interface adapter 250, and a display adapter 260, are operatively coupled to the system bus 202.

A first storage device 222 and a second storage device 224 are operatively coupled to system bus 202 by the I/O adapter 220. The storage devices 222 and 224 can be any of a disk storage device (e.g., a magnetic or optical disk storage device), a solid state magnetic device, and so forth. The storage devices 222 and 224 can be the same type of storage device or different types of storage devices.

A speaker 232 is operative coupled to system bus 202 by the sound adapter 230.

A transceiver 242 is operatively coupled to system bus 202 by network adapter 240.

A first user input device 252, a second user input device 254, and a third user input device 256 are operatively coupled to system bus 202 by user interface adapter 250. The user input devices 252, 254, and 256 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 252, 254, and 256 can be the same type of user input device or different types of user input devices. The user input devices 252, 254, and 256 are used to input and output information to and from system 200.

A display device 262 is operatively coupled to system bus 202 by display adapter 260.

Of course, the processing system 200 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 200 are readily contemplated by one of ordinary skill in the art given the teachings of the present principles provided herein.

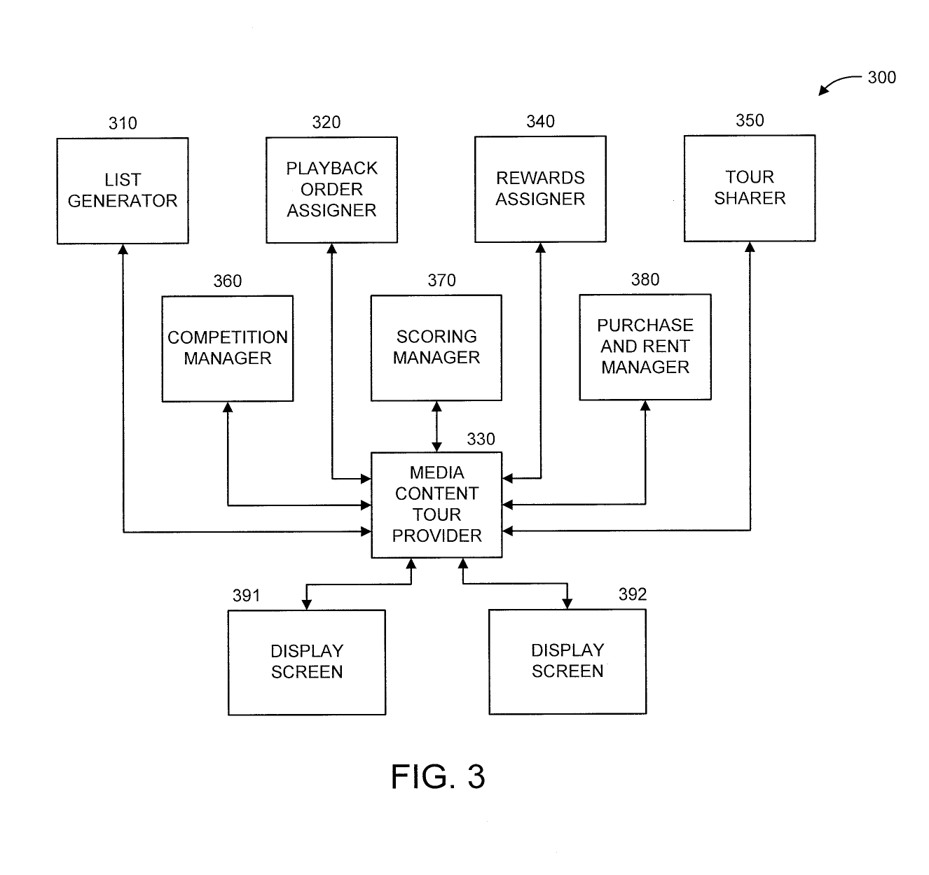

Moreover, it is to be appreciated that system 300 described below with respect to FIG. 3 is a system for implementing respective embodiments of the present principles. Part or all of processing system 200 may be implemented in one or more of the elements of system 300.

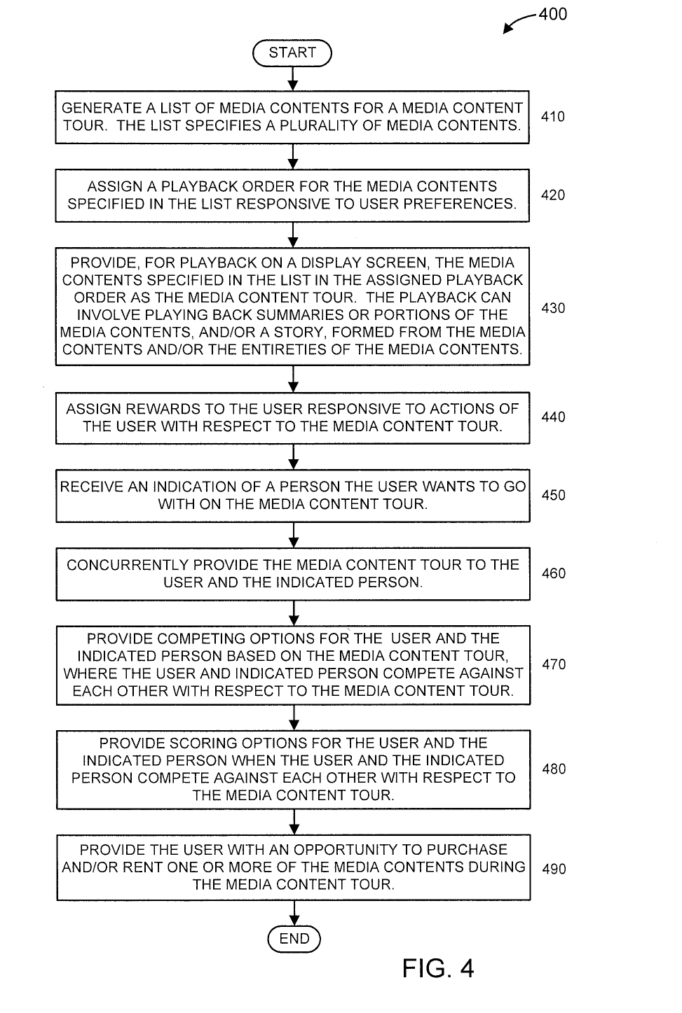

Further, it is to be appreciated that processing system 200 may perform at least part of the method described herein including, for example, at least part of method 400 of FIG. 4. Similarly, part or all of system 300 may be used to perform at least part of method 400 of FIG. 4.

FIG. 3 shows an exemplary system 300 for providing a media content tour, in accordance with an embodiment of the present principles. The system 300 includes a list generator 310, a playback order assigner 320, a media content tour provider 330, a rewards assigner 340, a tour sharer 350, a competition manager 360, a scoring manager 370, a purchase and rent manager 380, and two display screens 391 and 392.

The list generator 310 generates a list of media content for a media content tour. The list specifies a plurality of media contents.

The playback order assigner 320 assigns a playback order for the media contents specified in the list responsive to user preferences.

The media content tour provider 330 provides, for playback on a display screen, the media contents specified in the list in the assigned playback order as the media content tour. The playback can involve playing back summaries or portions of the media contents. The playback can involve a story, formed from the media contents in the list

The rewards assigner 340 assigns rewards to the user responsive to actions of the user with respect to the media content tour.

The tour sharer 350 receives an indication of a person the user wants to go with on the media content tour and provides a share request to the media content tour provider 330 responsive to receiving the indication. The media content tour provider 330 concurrently provides the media content tour to the user and the indicated person responsive to the share request provided by the tour sharer 350.

The competition manager 360 provides competing options for the user and the indicated person based on the media content tour, where the user and the indicated person compete against each other with respect to the media content tour.

The scoring manager 370 provides scoring options for the user and the indicated person when the user and the indicated person compete against each other with respect to the content media content tour.

The purchase and rent manager 380 provides the user with a purchase opportunity to purchase and/or rent one or more of the media contents during the media content tour.

Two display screens 391 and 392 playback the media tour for the user and the indicated person. While two display screens 391 and 392 are shown in the example of FIG. 3, any number of display screens can be used. For example, one display screen can be used in the case of a single user watching a media content tour. However, more display screens can be involved, for example, based on the number of people invited by the user to join the user in watching the media content tour. The user and the other people can be at the same or different locations. It is presumed that the user and the other people are using different media consumption devices that include a display screen. Of course, other arrangements are possible, while maintaining the spirit of the present principles.

While the display screens 391 and 392 are shown as part of the system 300 in FIG. 3, in other embodiments the system 300 may simply interact with the display screens 391 and 392, which can be part of a different system or device (such as a content consumption or content presentation device). Moreover, in an embodiment, the entirety of system 300 is part of a content consumption or content presentation device. Further, in other embodiments, one or more of the elements of system 300 can be distributed for use by more than one content consumption or content presentation device. Also, in an embodiment, one or more of the elements of system 300 can be part of a gaming device. These and other variations of the elements of FIG. 3 are readily determined by one of ordinary skill in the art, given the teachings of the present principles provided herein, while maintaining the spirit of the present principles.

Moreover, while shown separately, one or more of the list generator 310, the assigners 320 and 340, the tour sharer 350, and the managers 360, 370, and 380 can be included in the media content tour provider 330. In the exemplary configuration of FIG. 3, the list generator 310, the assigners 320 and 340, the tour sharer 350, and the managers 360, 370, and 380 interact with the media content tour provider 330. Of course, other configurations can be used. That is, these and various other configurations of system 300 are readily determined by one of ordinary skill in the art given the teachings of the present principles provided herein, while maintaining the spirit of the present principles.

FIG. 4 shows an exemplary method 400 for providing a media content tour, in accordance with an embodiment of the present principles.

At step 410, generate a list of media content for a media content tour. The list specifies a plurality of media contents.

At step 420, assign a playback order for the media contents specified in the list responsive to user preferences.

At step 430, provide, for playback on a display screen, the media contents specified in the list in the assigned playback order as the media content tour. In an embodiment, the playback can involve playing back summaries or portions of the media contents. In an embodiment, the playback can involve a story, formed from the media contents in the list. In an embodiment, the playback can involve playing back the entireties of the media contents

At step 440, assign rewards to the user responsive to actions of the user with respect to the media content tour.

At step 450, receive an indication of a person the user wants to go with on the media content tour. The indication essentially represents that the user wants to “share” the media content tour with the indicated person.

At step 460, concurrently provide the media content tour to the user and the indicated person.

At step 470, provide competing options for the user and the indicated person based on the media content tour, where the user and the indicated person compete against each other with respect to the media content tour.

At step 480, provide scoring options for the user and the indicated person when the user and the indicated person compete against each other with respect to the content media content tour.

At step 490, provide the user with an opportunity to purchase and/or rent one or more of the media contents during the media content tour.

In order to drive users to more media content, users should be recommended content tours which take the user on a journey through multiple pieces of content instead of just watching an individual piece of content. In an embodiment, the content tours can be recommended based on a user's ratings and past watching experiences (also collectively referred to herein as “user preferences”). In an embodiment, the content tours can be based around genre, television season, actor/actress, director, setting, location, mood or other content properties. It is to be appreciated that the preceding items upon which content tours can be based are merely illustrative and other items can be used. That is, given the teachings of the present principles provided herein, one of ordinary skill in the art will contemplate these and various other items upon which content tours can be based, while maintaining the spirit of the present principles. In an embodiment, the user is shown a simplified story that allows the user to explore content based on an individual content property or set of content properties. The user can complete a tour in a single session or can come back later to complete the tour.

In an embodiment, the present principles are part of a gamified system where the user gains points or other rewards (herein also collectively referred to as “rewards”) as the user proceeds through the tour. In an embodiment, the present principles are used in a social system where the user invites his family and friends to go on a tour with him. In an embodiment, the present principles are implemented in a social and gamified system where the user competes with his friends and family to complete the tour for points or other rewards. These and other implementations and applications of the present principles are readily determined by one of ordinary skill in the art, given the teachings of the present principles provided herein, while maintaining the spirit of the present principles.

A description will now be given of some exemplary media content tours, in accordance with various embodiments of the present principles.

One exemplary media content tour can be the “Beach Tour”. The Beach Tour can involve media content such as, for example, The Endless Summer, The Blue Lagoon, Blue Crush, Point Break, and Cast Away.

Another exemplary media content tour can be the “San Diego Tour”. The San Diego Tour can involve media content such as, for example, My Blue Heaven, K-9, Traffic, and Top Gun.

Still another exemplary media content tour can be the “Los Angeles Tour”. The Los Angeles Tour can involve media such as, for example, Mulholland drive, LA story, and Pretty Woman.

Yet another exemplary media content tour can be the “Bill Murray Tour”. The Bill Murray Tour can involve media content such as, for example, Caddyshack, Ghostbusters, Groundhog Day, The Royal Tenenbaums, and Lost in Translation.

Moreover, another exemplary media content tour can be the “Adventure Tour”. The adventure Tour can involve media content such as, for example, Raiders of the Lost Ark, Total Recall, Pirates of the Caribbean, and Inception

Further, another exemplary media content tour can be the “Katie Holmes Tour”. The Katie Holmes Tour can involve media content such as, for example, the first episode of Dawson's Creek, Go, Wonderboys, Disturbing Behavior, and Pieces of April.

Also, another exemplary media content tour can be the “John Hughes Tour”. The John Hughes Tour can involve media content such as, for example, Sixteen Candles, The Breakfast Club, Weird Science, and Ferris Bueller's Day Off.

A description will now be given of exemplary information presented to a user during a media content tour, in accordance with an embodiment of the present principles.
(1) Welcome to M-Go Tours™! We hope to be your tour guide and help you explore the entertainment world. Here are some tours, we think you would like! Choose your journey!
(2) Purchase/Rent entire tour content or individual content for the tour.
(3) Invite your friends to come on a tour with you!
(4) Mike accepted your invitation. Are you ready to watch your first piece of content?
(5) Purchase and watch the first piece of content.
(6) How did you like that? You earned 10 points! The next stop is . . . Would you like to continue the tour?
(7) Purchase and watch next movie.
(8) You are beating your friend Mike, but Mike is catching up! You earned an extra 20 points!
(9) Watch more movies.
(10) You just finished your tour! You earned 50 points and a reward for a free rental. You are 100 points from the next level. Would you like to try another tour?

A description will now be given regarding an exemplary layout for providing a media content tour to a user, in accordance with an embodiment of the present principles.

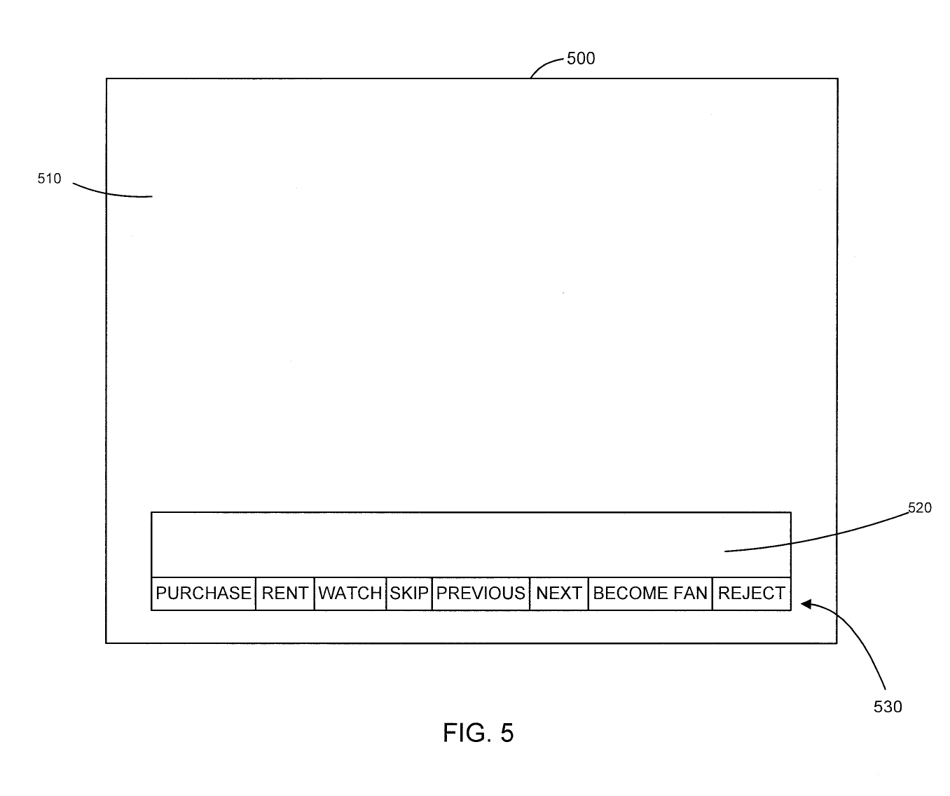

FIG. 5 shows an exemplary user interface 500 for a media content tour, in accordance with an embodiment of the present principles. The user interface 500 includes an area 510 for presenting artwork and/or text corresponding to at least one of multiple media contents that are part of a media content tour. In an embodiment, the area 510 can also be used for presenting the list of media contents for a media tour as described herein (e.g., as shown and described with respect to at least FIG. 6). In another embodiment, the area 520 described hereafter can be used for presenting the list of media content for a media tour. The user interface 500 also includes an area 520 for providing media recommendations and/or other media content tour related information to a user. The media recommendations can be, for example, regarding a next stop on the tour or media that the user preferences have indicated the user is a fan of. The user interface 500 further includes media control buttons 530 for controlling a playback of the media content tour. The media control buttons 530 can include, for example, but are not limited to, a purchase button, a rent button, a watch button, a skip button, a previous button, a next button, a “become fan” button, a reject button, and so forth. The “become fan” button can be used to indicate that the user has become (or is) a fan of a certain media related item (e.g., a media content itself, and/or something related to the media content, such as an actor, director, and so forth). The reject button is used to indicate that the user is not a fan of something currently shown. In an embodiment, the reject button can be used to prune out recommendations that include items for which the user has actuated the reject button. Moreover, the use of any of the preceding buttons can form the basis of user preferences for future use by the present principles in provided a media content tour and/or can affect the currently playing tour. In an embodiment, the use of the reject button automatically implicates the skip button so that the current item is rejected and skipped. It is to be appreciated that the preceding functions relating to the aforementioned buttons are merely exemplary and other functions can also be used, while maintaining the spirit of the present principles. Moreover, while buttons have been shown for exemplary purposes, it is to be appreciated that other control mechanisms can also be used to implement the present principles. Further, the layout of the user interface 500, including but not limited to the arrangements of the areas 510 and 520 as well as the media control buttons 530, is provided for exemplary purposes and, thus, other layouts can also be used, as readily contemplated by one of ordinary skill in the art given the teachings of the present principles provided herein, while maintaining the spirit of the present principles.

A description will now be given of content list generation, in accordance with an embodiment of the present principles.

The generation of the tour can start with a play out list (curated list) which has been pre-designated, e.g., by a human or automated method. For example, a list can be generated where a user wants all of the movie elements that take place in a specific location such as London or Chicago.

In an embodiment, we associate such a list with X elements, which go in the order of X1, X2, . . . , XN (N being an integer associated with the total number of elements in the curated/generated list).

In an embodiment, we swap out elements with new elements Y1 and so forth which can replace various elements in the list to produce something like X1, X2, Y1, X4, Y2 . . . XN. The replacement of such elements can be performed in accordance with a user's profile where the following scenarios can be used for replacing X elements with Y elements:
(1) A user profile indicates the type of assets that a user may like to watch (sports, action movies, and the like). The Y element that ends up replacing an X element is related to the preferences of a user. That is, in an embodiment, the content tour begins with elements X1, . . . , XN where the list itself is related to either the curated list generated by someone else, or is generated in view of a topic or theme. The replacement of an element X with an element Y reflects the actual preferences of a user. The frequency of the replacement and/or what X element is replaced can be random or predetermined.
(2) The replacement can also reflect time based data where the oldest existing X element is replaced with the new Y element. This can be done in a case where Y corresponds to a new television show or other programming that can be used to “shake up” a list that is pre-generated. Hence, if a pre-generated list of X1 to XN represents movie trailers for science fiction movies, at certain points X elements are replaced with Y elements, where in this example Y represents the newest trailers for movies that are coming up. A value can be set by a user or a content provider which designates how many X elements are to be replaced with Y elements.
(3) Lists can also be generated based on the preference choices made by a user. Such lists can be displayed, e.g., on area 510 and/or area 510 of the user interface 500 of FIG. 5 as described above.

A description will now be given of some of the many attendant advantages/features of the present invention, some of which have been mentioned above. For example, one advantage/feature is a method that includes generating a list of media content for a media content tour, the list specifying a plurality of media contents. The method further includes assigning a playback order for the media contents specified in the list responsive to user preferences. The method also includes providing, for playback on a display screen, the media contents specified in the list in the assigned playback order as the media content tour.

Another advantage/feature is the method as described above, further including assigning rewards to the user responsive to actions of the user with respect to the media content tour.

Yet another advantage/feature is the method as described above, further including receiving an indication of a person the user wants to go with on the media content tour, and concurrently providing the media content tour to the user and the indicated person.

Still another advantage/feature is the method further including receiving an indication of a person the user wants to go with on the media content tour, and concurrently providing the media content tour to the user and the indicated person as described above, wherein the method further includes providing competing options for the user and the indicated person based on the media content tour, wherein the user and the indicated person compete against each other with respect to the media content tour.

Moreover, another advantage/feature is the method wherein the method further includes providing competing options for the user and the indicated person based on the media content tour, wherein the user and the indicated person compete against each other with respect to the media content tour, and wherein the method further includes providing scoring options for the user and the indicated person when the user and the indicated person compete against each other with respect to the content media content tour.

Further, another advantage/feature is the method as described above, wherein the playing back step comprises playing back summaries or portions of the media contents.

Also, another advantage/feature is the method as described above, further including providing the user with a purchase opportunity to at least one of purchase and rent one or more of the media contents during the media content tour.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method, comprising:
generating a list of media content for a media content tour, the list specifying a plurality of media contents;
assigning a playback order for the media contents specified in the list responsive to user preferences of a user; and
providing, for playback on a display screen, the media contents specified in the list in the assigned playback order as the media content tour.

2. The method of claim 1, further comprising assigning rewards to the user responsive to actions of the user with respect to the media content tour.

3. The method of claim 1, further comprising:
receiving an indication of a person the user wants to go with on the media content tour; and
concurrently providing the media content tour to the user and the indicated person.

4. The method of claim 3, further comprising providing competing options for the user and the indicated person based on the media content tour, wherein the user and the indicated person compete against each other with respect to the media content tour.

5. The method of claim 4, further comprising providing scoring options for the user and the indicated person when the user and the indicated person compete against each other with respect to the content media content tour.

6. The method of claim 1, wherein said providing step comprises providing, for playback on the display screen, summaries or portions of the media contents specified in the list in the assigned playback order as the media content tour.

7. The method of claim 1, further comprising providing the user with an opportunity to at least one of purchase and rent one or more of the media contents during the media content tour.

8. A system, comprising:
a list generator for generating a list of media content for a media content tour, the list specifying a plurality of media contents;
a playback order assigner for assigning a playback order for the media contents specified in the list responsive to user preferences of a user; and
a media content tour provider for providing the media contents specified in the list for playback in the assigned playback order as the media content tour.

9. The system of claim 8, further comprising a rewards assigner for assigning rewards to the user responsive to actions of the user with respect to the media content tour.

10. The system of claim 8, further comprising a tour sharer for receiving an indication of a person the user wants to go with on the media content tour and providing a share request to the media content tour provider, wherein the media content tour provider concurrently provides the media content tour to the user and the indicated person responsive to the share request.

11. The system of claim 10, further comprising a competition manager for providing competing options for the user and the indicated person based on the media content tour, wherein the user and the indicated person compete against each other with respect to the media content tour.

12. The system of claim 11, further comprising a scoring manager for providing scoring options for the user and the indicated person when the user and the indicated person compete against each other with respect to the content media content tour.

13. The system of claim 8, wherein said media content tour provider provides, for playback on the display screen, summaries or portions of the media contents specified in the list in the assigned playback order as the media content tour.

14. The system of claim 8, further comprising a purchase and rent manager for providing the user with an opportunity to at least one of purchase and rent one or more of the media contents during the media content tour.

15. A non-transitory computer readable storage medium having computer executable code stored thereon for performing a method, the method comprising:
generating a list of media content for a media content tour, the list specifying a plurality of media contents;
assigning a playback order for the media contents specified in the list responsive to user preferences of a user; and
providing, for playback on a display screen, the media contents specified in the list in the assigned playback order as the media content tour.
